(19) United States
(12) Patent Application Publication
(10) Pub. No.: US 2002/0114760 A1
(43) Pub. Date: Aug. 22, 2002

(54) Selective oxidation of kraft cooking liquors

(76) Inventors: Sebastien Corbeil, Darien, IL (US); Meenakshi V. Sundaram, Burr Ridge, IL (US); Karine Saint-Cyr, Westmont, IL (US)

Correspondence Address: E. Joseph Gess, Esq., BURNS, DOANE, SWECKER & MATHIS, L.L.P., P.O. Box 1404, Alexandria, VA, 22313-1404, US

(21) Appl. No.: 09/784,076

(22) Filed: Feb. 16, 2001

(51) Int. Cl. C01B 17/34

(52) U.S. Cl. 423/562

(57) ABSTRACT

Provided is a process for the preparation of polysulfides which comprises reaching sodium sulfide with oxygen in the presence of a transition metal oxide, preferably MnO₂, and with the consumption rate of O₂ being at least 1.5×10⁻⁴ moles/l/sec. The process of the present invention is preferably conducted in a self-recirculated reactor, which has been found to allow easy control of the O₂ consumption rate.

### BACKGROUND OF THE INVENTION

1. Field of the Invention

The present invention relates to the oxidation of sodium sulfide in Kraft cooking liquors. More specifically, the present invention relates to a method of selectively oxidizing sodium sulfide to sodium polysulfide in Kraft cooking liquors, minimizing the formation of sodium thiosulfate.

2. Brief Description of the Related Art

In the conventional Kraft cooking process, two chemicals, namely sodium hydroxide and sodium sulfide, are used to delignify the wood chips. During the course of the reaction, part of the undesired fraction of wood, lignin, is solubilized and removed. However, cellulose and hemicelluloses, which are desirable components, are also attacked. Hence, one of the goals sought during cooking is to protect this fraction in order to achieve a better process yield.

Theoretically, it should be possible to fully retain cellulose and hemicelluloses. The weight contribution of these components varies with each wood species but is usually around 70%. However, in an industrial process, the amount retained is more in the order of 45-50%. Typically, 80% of the lignin, 50% of the hemicelluloses and 10% of the cellulose are removed. The hemicelluloses are easily attacked since they are low molecular weight sugars that are more accessible than crystalline cellulose. The mechanism by which they are removed is called alkaline peeling and occurs at the reducing end group of the polymeric chain.

It is well known that in order to increase the carbohydrate yield in the Kraft cooking process, polysulfides can be introduced in the digester. This prevents the degradation of the polysaccharides and increases the yield for a given lignin content. This concept was first discussed by Haegglund in 1946 (Svensk Papperstidn. 49(9):191, 1946).

Polysulfides can be generated by various, different means. In one approach, polysulfides are formed by adding elemental sulfur to the white liquor. However, adding elemental sulfur leads to imbalances in the sulfur balance of the chemical recovery cycle. The build up of sulfur will eventually be released to the atmosphere as a sulfur gas emission. For this reason, this approach has very limited industrial interest.

A second approach consists of chemically oxidizing the sodium sulfide present in the white liquor to sodium polysulfides. The resulting polysulfide liquor is known in the art as orange liquor. This method involves several chemical species, but in general, assuming a polysulfide chain length of n=2, the chemical reactions can be written as follows:

2HS⁻+2O₂⇄2 S₂S⁻²+2OH⁻+2H₂O (1)

2S₂S⁻²+4O₂+2OH³¹⇄3S₂O₃+H₂O (2)

2HS⁻+2O₂⇄S₂O₃⁻²+H₂O (3)

2HS⁻+3O₂2SO₃⁻²+2H⁺ (4)

2SO₃⁻²+O₂⇄2SO₄⁻² (5)

One goal sought during the oxidizing is to maximize the formation of polysulfides and minimize the formation of dead load and more specifically thiosulfate. This is measured by selectivity, a term known in the art which corresponds to the amount of polysulfides formed/amount of converted sulfide on a sulfur basis.

Several variations of this oxidative method have been published. In U.S. Pat. No. 3,470,061, Barker discloses a method using inorganic manganese oxides as the oxidant. In this respect, the chemical equation involving polysulfides can be written as:

MnO₂+2Na₂S+H₂O⇄MnO+Na₂S₂+2NaOH (6)

Once reduced, the catalyst is reoxidized with air or oxygen after separation from the white liquor according to:

MnO+½O₂⇄MnO₂ (7)

This oxidation is performed in an external recycle loop after the catalyst has been separated and dried. However, said process has several drawbacks. First, the amount of catalyst needed to form the desired quantity of polysulfides is very high. Second, separating and drying the catalyst is complex and not economically sound.

In U.S. Pat. No. 3,860,479, Barker discloses a method in which the manganese dioxide catalyst is regenerated in situ without the need of an external recycle loop. This process overcomes some of the drawbacks of U.S. Pat. No. 3,470,061, but requires large retention times.

In U.S. Pat. No. 4,024,229, Smith discloses a method to generate polysulfides by chemical oxidation using particulate carbon, coated with a PTFE, as the catalyst. The method is said to reduce the production of thiosulfate. However, said process requires particulate free white liquor and therefore requires a filtration step before the production of polysulfides. Moreover, the catalyst bed has to be regenerated due to deactivation of the catalyst by particles of calcium carbonate.

In U.S. Pat. No. 4,855,123, Suzuki et al. disclose a method similar to that of U.S. Pat. No. 4,024,229. However, in this case, the catalyst is activated carbon. This invention offers the same drawbacks as the previous disclosure.

In U.S. Pat. No. 5,082,526, Dorris discloses a method to produce polysulfides in the presence of lime mud. The disadvantages of this method is that it requires long oxidation time because it uses the existing causticizers which require residence times of about 50 minutes. This leads to a lower selectivity because of overoxidation and thermal degradation of the polysulfide.

In U.S. Pat. No. 5,624,545, Landfors et al. disclose a method to produce polysulfides by electrolysis of the white liquor. Said method has the drawback of having high capital and energy cost.

In WO patent 97/42372, Yant et al. disclose a method to produce polysulfides from white liquor. In this process an inorganic metal is used as a catalyst, similarly to U.S. Pat. No. 3,860,479. The catalyst is then separated by centrifugal action and reintroduced with an oxygen-containing gas into a specially designed reactor. However, said process has the drawbacks of requiring a large footprint and high capital costs. Moreover, the separation of the highly concentrated catalyst is difficult and its loss could adversely effect the pulping and bleaching process.

Therefore, there are many different processes available to produce polysulfides from white liquors to thereby increase the yield in Kraft cooking. However, the processes are generally either complicated, or less than cost effective. It is an object of the present invention to provide an improved, cost effective/efficient process for the oxidation of sodium sulfide to sodium polysulfide in Kraft cooking liquors.

### SUMMARY OF THE INVENTION

The present invention provides a simple and efficient method of producing polysulfides without the drawbacks associated with the prior methods. It also permits an increase in the production of sodium polysulfides while decreasing the amount of sodium thiosulfate dead-load, thereby maximizing the polysulfide production while also maximizing its selectivity.

During the oxidation of sodium sulfide with an oxygen-containing gas, several products can be formed according to equations 1 through 7, as noted above. While the prior art describes several processes to carry out the reaction, it fails to describe how to produce sodium polysulfides in an efficient manner. i.e rapidly, economically and selectively.

The present invention provides for the highest possible selectivity while using the lowest amount of a transition metal oxide catalyst, preferably MnO₂. This allows one to minimize the problems of using a transition metal oxide catalyst such as MnO₂ in the overall process since it is a contaminant. These objectives are achieved through the utilization of a high mass transfer of oxygen, such that the consumption rate of oxygen is at least 1.5×10⁻⁴, more preferably at least 2×10⁻⁴ and most preferably at least 4×10⁻⁴ moles/l/sec. This consumption rate of oxygen is controlled quite easily through a control of the partial pressure of oxygen, which is most preferably, and believed best achieved, through the use of a self-recirculated reactor. The present method further allows the residence time to be maintained at a minimum, and maximizes the oxygen consumed.

More specifically, the present process relates to the preparation of polysulfides, which process comprises reacting Na₂S with oxygen in the presence of a transition metal oxide catalyst such as MnO₂, with the concentration of the catalyst ranging from 0.05 to 6.5 g/l, and where the consumption rate of O₂ is at least 1.5×10⁻⁴ moles/l/sec, such that a selectivity of polysulfides greater than 65% is achieved. The particular consumption rate of oxygen must be at least 1.5×10⁻⁴ moles/l/sec, but the preferred amount is liquor dependent. A control of the partial pressure of the oxygen allows one to maximize oxygen consumption and selectivity for any particular liquor used.

### BRIEF DESCRIPTION OF THE FIGURES OF THE DRAWINGS

FIG. 1 shows a layout of the recaustification process where the present invention is used on unclarified white liquor.

FIG. 2 shows a layout of the recaustification process where the present invention is used on green liquor.

FIG. 3 shows a layout of the recaustification process where the present invention is used on clarified white liquor.

FIG. 4 shows a layout of the recaustification process where the present invention is used on clarified white liquor with a split addition to the digester.

FIGS. 5 to 10 show different possible variations of a self-recirculated reactor, all useful in producing sodium polysulfides in accordance with the present invention.

FIG. 11 shows a self-recirculating hollow shaft reactor used to carry out the process of the present invention in the examples.

FIG. 12 graphically depicts the evolution of sodium thiosulfate and sodium polysulfides at two different oxygen partial pressures.

FIG. 13 graphically depicts the impact of catalyst concentration on selectivity for two different liquors.

FIG. 14 shows the impact of total pressure on selectivity.

FIG. 15 shows the impact of mixing rate and partial pressure on selectivity.

FIG. 16 shows the impact of lime mud on selectivity.

FIG. 17 graphically shows the effect of temperature on selectivity and time to reach a desired residual sulfide.

FIG. 18 graphically shows residence time in polysulfide production relative to the oxygen mass transfer.

### DETAILED DESCRIPTION OF THE PREFERRED EMBODIMENTS OF THE INVENTION

The present invention provides one with a process for preparing polysulfides. The process comprises reacting sodium sulfide with oxygen in the presence of a catalytic amount of a transition metal oxide catalyst, most preferably manganese dioxide. It is important for the present invention that the concentration of the catalyst, e.g., manganese dioxide, be in the range of from about 0.05 to 6.5 g/l, and most importantly that the consumption rate of oxygen be at least about 1.5×10⁻⁴ moles/l/sec. The concentration of the catalyst, and in particular the consumption rate of oxygen is controlled such that the selectivity of polysulfides is greater than 65%. The optimum consumption rate of oxygen varies depending upon the particular composition of the liquor involved. However, it has been found that by controlling of the consumption rate of oxygen to be at a minimum 1.5×10⁻⁴, and more preferably 2×10⁻⁴ moles/l/sec, a highly selective, efficient and cost effective process for preparing polysulfides is achieved. This process overcomes the problems of high selectivity with low capital investment. The residence time can be comparatively short, e.g., in the range of from 2 to 15 minutes, more preferably from 3 to 10 minutes, and most preferably from 3 to 5 minutes, so only a small piece of equipment is needed in terms of a reactor to effect the process for preparing polysulfides. The result is that one can use an existing plant and simply insert the reactor. Due to the small size, there is room, and the insertion is easily achieved.

The necessary control of the consumption rate of oxygen, in a most preferred embodiment, is easily realized by controlling the partial pressure of oxygen. This control of the partial pressure of oxygen is most preferably achieved through the use of a hollow shaft reactor. The partial pressure of oxygen is easily controlled by using a hollow shaft reactor. It is also most preferred that the oxygen employed is at least 80% pure oxygen. The source of the oxygen can be any suitable oxygen source. For example, a VSA (vacuum swing adsorption) unit, which provides 93% O₂, can be the supply source. If an ozone generator is on site, the off gas from the application stage, generally comprising around 80% O₂, can be used. The benefit in the preferred embodiment of using pure oxygen is that the retention time can be kept relatively short. If air had to be used in the reaction, a much longer retention time would be needed to effect the reaction.

While manganese dioxide is the preferred catalyst, any transition metal oxide can in fact be used. A mixture of such catalytic transition metal oxides can also be used. The concentration of the catalyst in the present process ranges from 0.05 to 6.5 grams/liter. This is greater than that generally found inherently in lime mud, and therefore requires the addition of catalyst. A transition metal oxide other than manganese oxide can be added if desired, for purposes of the present invention. Preferably, however, manganese oxide is added as it has been found to be effective. The temperature at which the reaction is conducted is also preferably in the range of from 70 to 99° C., more preferably in the range of from 75 to 85° C., and most preferably in the range of from 75 to 80° C. It has been found that operation within this narrow temperature range shows a surprising achievement in selectivity.

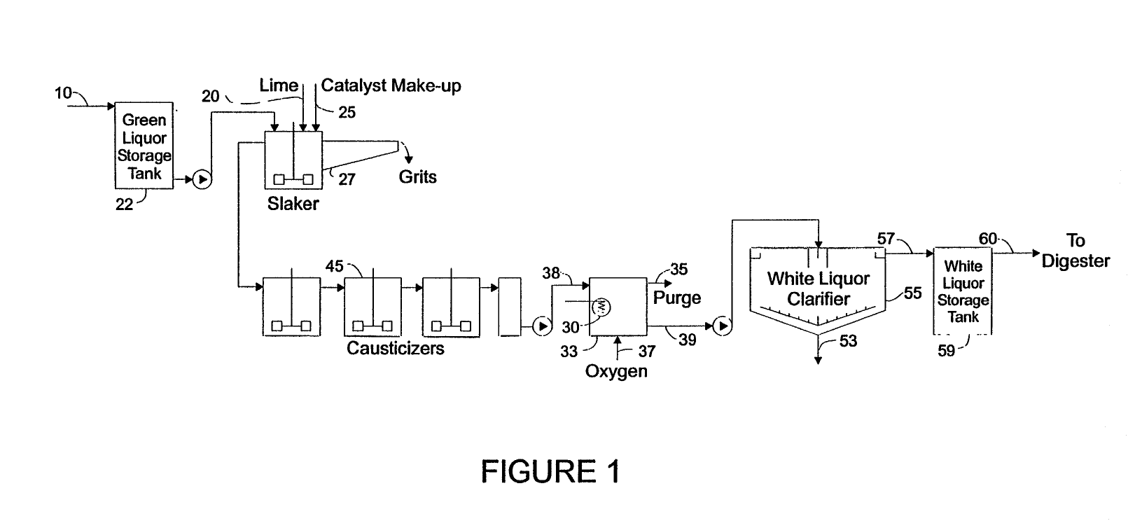

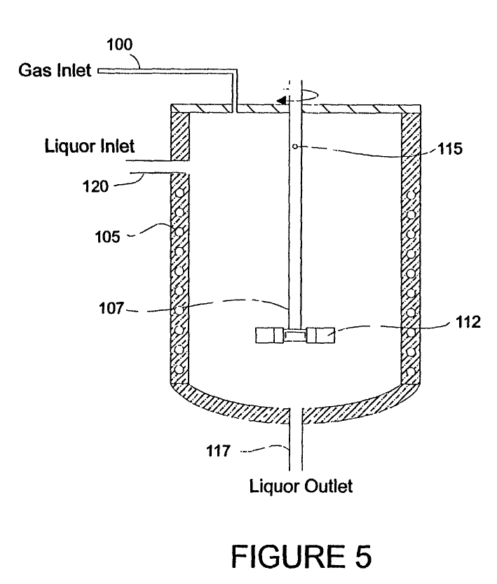

The preferred embodiments of the present invention will now be described in greater detail by reference to the figures of the drawing. It should be noted that in FIGS. 1-4, the same reference numerals are used in each of the figures to represent the same equipment. This is also true in FIGS. 5-10, which depict various embodiments of suitable self-recirculated, hollow shaft reactors.

As shown in FIG. 1, in a recaustification plant, green liquor 10 is initially stored in a storage tank 22. The liquor is then pumped to a slaker 27 where quick lime 20 is converted into slaked lime. This slurry is then sent to a series of causticizers 45 where sodium carbonate is converted to sodium hydroxide. In U.S. Pat. No. 5,082,526, the causticizers are modified or alternatively, a pipeline reactor is added to allow oxygen to be sparged and mixed with the white liquor in order to produce polysulfides. In the present invention, the oxidation occurs in a high mass transfer reactor, and preferably occurs in a self-recirculated reactor 33 located after the causticizers. Unclarified white liquor 38 is introduced in the reactor 33 and an oxygen-containing gas 37 is bubbled in the reactor. The temperature is carefully controlled to be between 70° C. and 99° C., optimally 80° C., with cooling water in the jacket of the reactor 30. The selectivity is maintained to at least 65%, and more preferably at least 75%, by carefully adjusting the ratio of catalyst addition 25, such as manganese dioxide, and the oxygen partial pressure. The amount of catalyst added to the system must be maintained at concentration between 0.05 and 6.5 g/l.

The partial pressure is controlled by adjusting the purge rate 35 when inert gases are present. Alternatively, an inert can be added to the reactor to maintain the desired partial pressure. When this ratio is maintained at the optimum, the oxygen consumption must be maximized to prevent the formation of sodium thiosulfate. In one embodiment, this is done via the use of a self-recirculating reactor 33 which allows one to minimize the reaction time to 2-10 minutes, optimally around 3-5 minutes. The resulting orange liquor 39 contains sodium polysulfides in the range of 3 to 15 g/L and a minimum amount of sodium thiosulfate. The orange liquor is then sent to a white liquor clarifier, or alternatively a pressure filter 55. The lime mud and catalyst 53 are separated from the orange liquor and sent to the lime kiln. The clarified orange liquor 57 is then sent to a storage tank 59. Finally, the liquor 60 is sent to the digester for cooking.

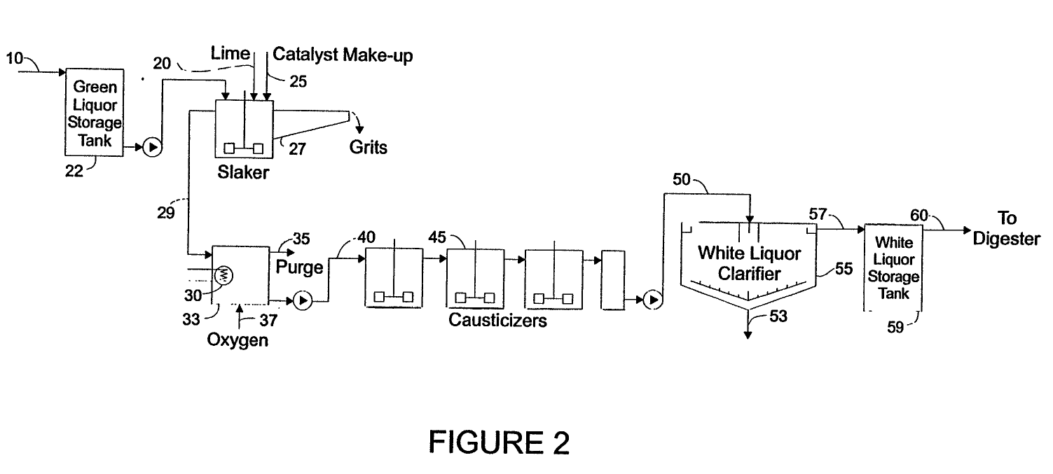

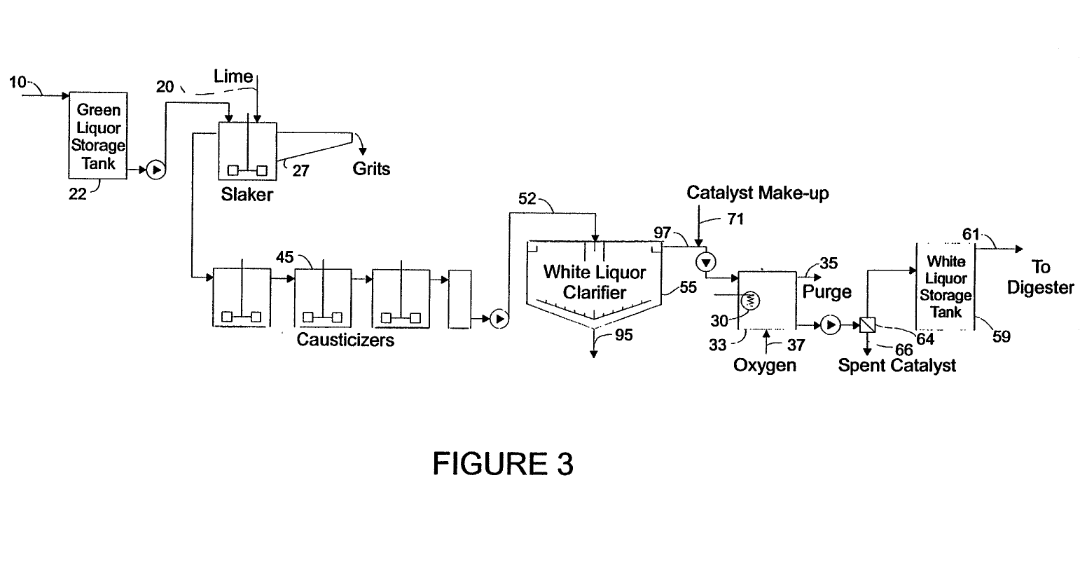

In another embodiment of the invention, shown in FIG. 2, green liquor 29 is oxidized in the same fashion as described above. In yet another embodiment, shown in FIG. 3, the oxidation is performed after the clarification. White liquor 52 is sent to the clarifier 55, or alternatively pressure screens and the lime mud 95 is sent back to the lime kiln. The clarified white liquor 97 is sent to the self-recirculating reactor where the oxidation is performed by controlling the selectivity by adjusting the oxygen partial pressure 37, catalyst addition 71, and the purge rate 35. The liquor is then separated from the catalyst in a separation vessel 64 and the spent catalyst 66 is reused or alternatively maintained in the reactor.

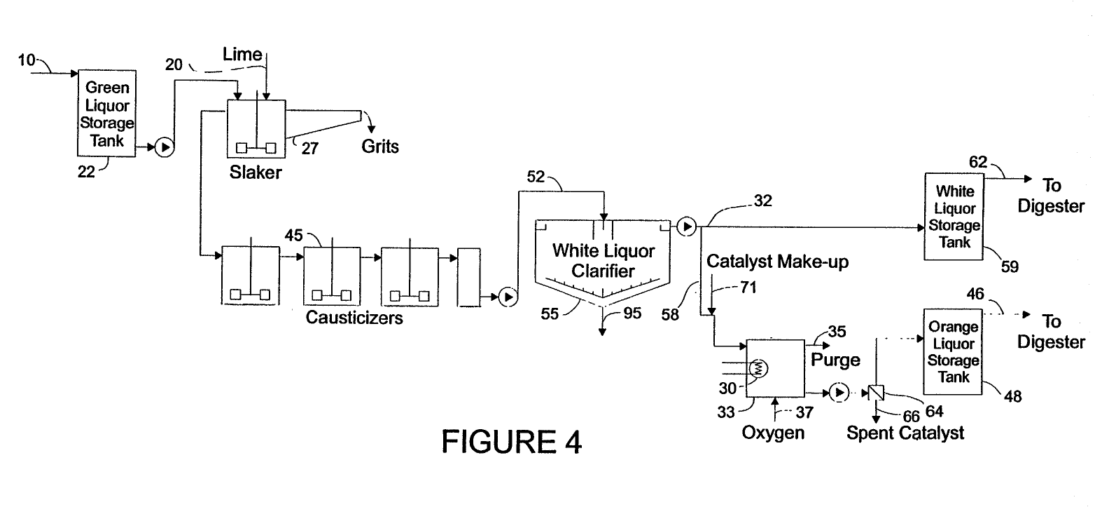

In yet another embodiment, described in FIG. 4, the clarified white liquor exiting the white liquor clarifier 55 is split in two fractions. One fraction 32, is sent to the white liquor storage tank 59. The white liquor is then sent to the lower cooking zone of a split addition digester. The other fraction 58 is sent to the hollow shaft reactor 33 to be oxidized to sodium polysulfides. The orange liquor is then sent to a storage tank 48. Afterward, the liquor is sent to the impregnation stage of the digester to allow the cooking yield to be increased.

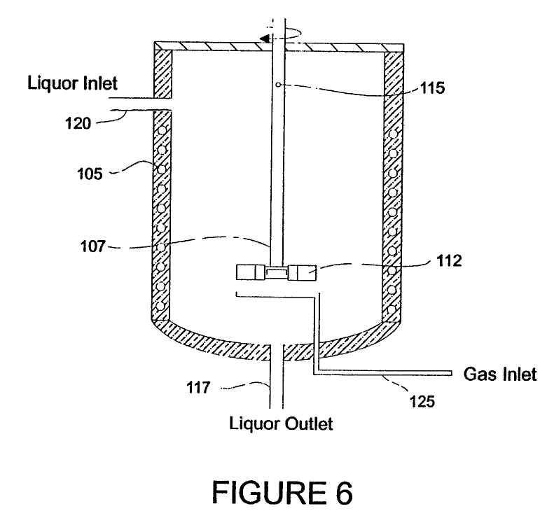

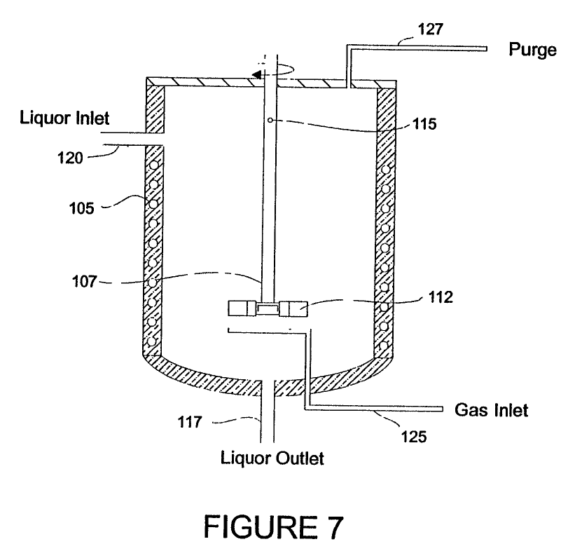

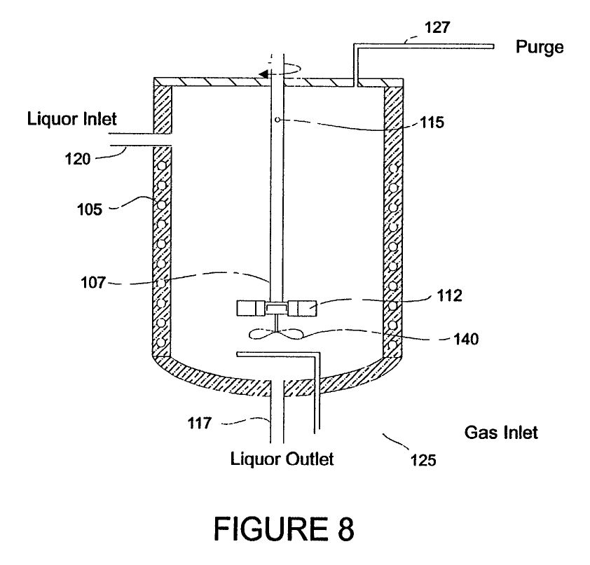

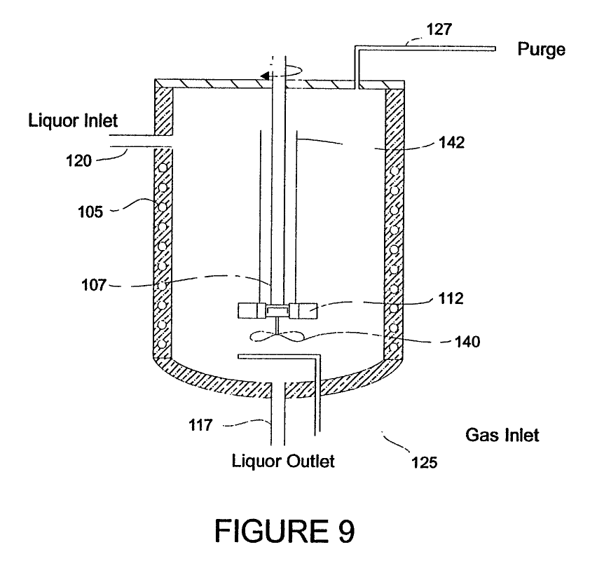

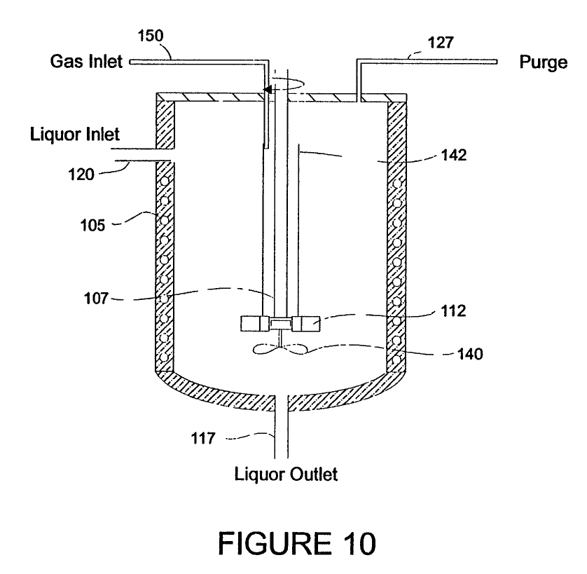

In a most preferred embodiment of the present invention, the self-recirculated reactor used for the reaction is a hollow shaft reactor. Such reactors are depicted in FIGS. 5-10 of the drawing, and are more particularly described in copending U.S. application Ser. No. ______ (Attorney Docket No. 016499-895/Serie 5540), filed concurrently herewith. White liquor is introduced in the reactor through the inlet 120. Oxygen gas of at least 80% concentration is introduced in the reactor through the gas inlet 100. The shaft 107, which is hollow, recirculates the oxygen and water vapor from the orifice 115 to the turbine 112. The recirculation allows 100% consumption of the gas and therefore no gas outlet is required. The orange liquor exits through the liquor outlet 117. In yet another embodiment, shown in FIG. 6, the oxygen-containing gas is introduced from a perforated pipe 125 located under the turbine. The unreacted oxygen is then recirculated through the shaft 107. In another embodiment, FIG. 7, a gas with inerts greater than that found in commercially pure oxygen is introduced through the inlet 125. A large fraction of the unreacted oxygen-inert mixture is recirculated through the hollow shaft 107. A smaller fraction of the unreacted mixture is removed via a purge 127 which controls the oxygen partial pressure. In another embodiment, FIG. 8, another turbine 140 is added to maintain the catalyst in suspension. In yet another embodiment, FIG. 9 shows that the oxygen-containing gas is recirculated through a double envelope 142 around the shaft 107 of the reactor. In another embodiment, FIG. 10, the oxygen-containing gas is introduced 150 directly in the double envelope 142 of the shaft 107.

Practice of the present invention as described above, with its control of the partial pressure of oxygen to insure an oxygen consumption (mass transfer) of at least 1.5×10⁻⁴ moles/l/sec, more preferably at least 2×10⁻⁴ moles/l/sec and most preferably at least 4×10⁻⁴ moles/l/sec, allows one to achieve selectivities of polysulfides of greater than 65%, greater than 75% and even greater than 90%, simply and efficiently. The preferred use of a self-recirculated reactor permits O₂ partial pressure control to be accomplished most readily and easily for the purposes of the present invention.

The invention will be illustrated in greater detail by the following specific examples. It is understood that these examples are given by way of illustration and are not meant to limit the disclosure of the claims to follow. All percentages in the examples, and also in the specification, are by weight unless otherwise specified.

### EXAMPLES

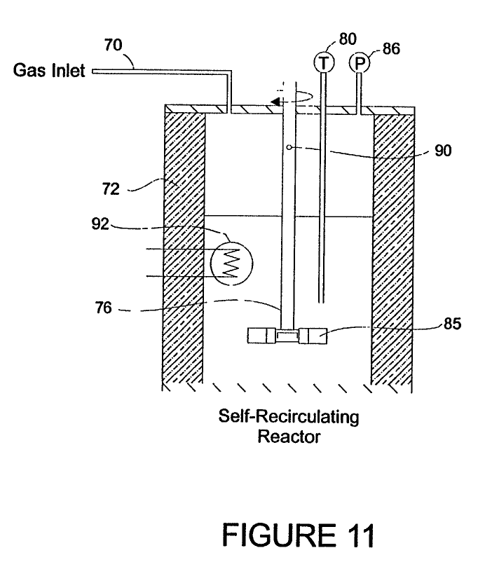

Several experiments were conducted to determine the optimum oxygen partial pressure to catalyst ratio at laboratory scale. The apparatus used is the hollow shaft reactor shown in FIG. 11. The apparatus is comprised of a heating jacket 72, used to bring the liquor to the desired temperature, and a cooling coil 92, used to remove the heat generated during oxidation. The temperature was tightly controlled using a probe 80 and the pressure was monitored using a transducer 86. Gas was introduced in the headspace of the vessel through the inlet 70. The headspace gas which could comprise nitrogen, oxygen and water vapor was aspirated by an orifice 90 and circulated through the hollow shaft 76 and then dispersed in fine bubbles through the turbine 85. This provided very efficient mass transfer of the oxygen containing gas and full consumption of the oxygen.

### Example 1

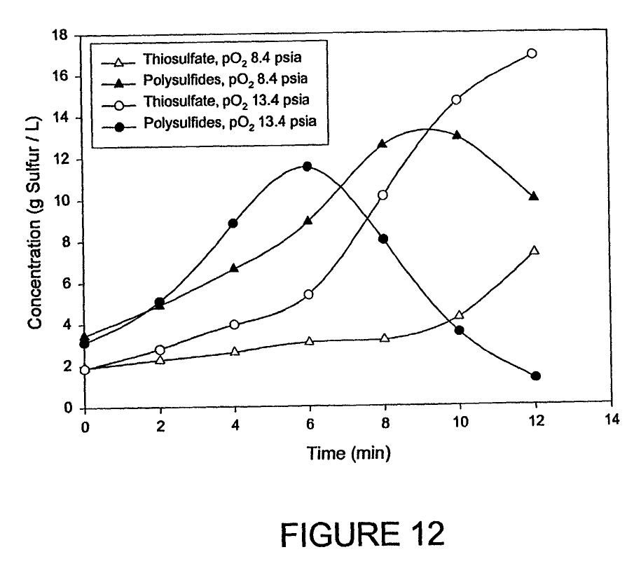

A white liquor containing 17.2 g/l sodium sulfide (as sulfur), 2.1 g/l sodium thiosulfate, 2.2 g/l sodium sulfate, 0.12 g/l sodium sulfite and 99 g/l lime mud was oxidized in the vessel described above. 0.25% (w/w) manganese dioxide was added to the lime mud to catalyze the reaction. The temperature in the reactor was maintained at 80° C. Substantially pure oxygen was introduced in the headspace while maintaining a mixing speed of 1500 rpm. FIG. 12 shows the evolution of sodium polysulfide and sodium thiosulfate at two different oxygen partial pressures, i.e., a pO₂ of 8.4 psia and a pO₂ of 13.4 psia. The graph shows that when the oxygen partial pressure is higher at the same catalyst charge, the rate of sodium thiosulfate formation can increase faster than the rate of sodium polysulfides formation, thereby yielding a lower selectivity. This demonstrates the need to control the oxygen partial pressure to achieve maximum selectivity, and that the highest partial pressure of O₂ is not necessarily the most desired.

### Example 2

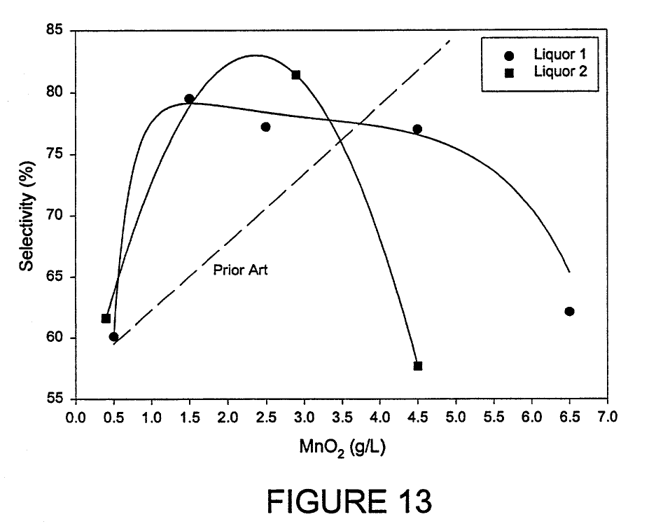

Two different liquors containing lime mud were oxidized as described in Example 1 at multiple catalyst levels, the various catalyst levels being shown in FIG. 13. Graphically, FIG. 13 shows that for both liquors, the selectivity is increased by adding MnO₂ to the lime mud to catalyze the reaction. The selectivity is increased until a certain level is reached. Unexpectedly, the selectivity decreases after the critical concentration for that liquor. In the prior art, it was thought that selectivity reached a plateau and was maintained after the critical concentration level was reached, which is not the case. The graph also shows that different liquors will have different critical catalyst concentrations due to the impurities present in the liquor and the lime mud.

### Example 3

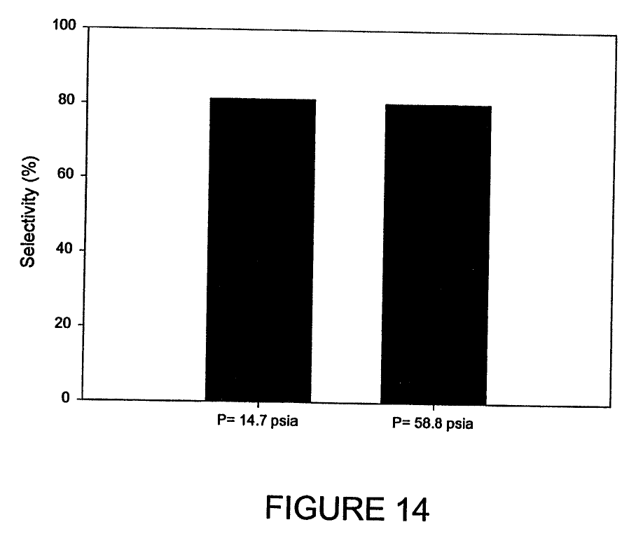

In order to investigate the effect of total pressure, a white liquor that was oxidized at 14.7 psia was also oxidized at a higher pressure, i.e., 58.8 psia. Forty-four psia of nitrogen gas was added to the water vapor/oxygen mixture so that the total pressure in the system was 58.8 psia. The oxygen partial pressure was maintained at 8.4 psia; the vapor pressure was 6.4 psia. The nitrogen was constantly recirculated in the liquid through the hollow shaft of the reactor. FIG. 14 shows that for a given oxygen partial pressure, the selectivity is maintained independently of the total pressure, when all other variables are maintained.

### Example 4

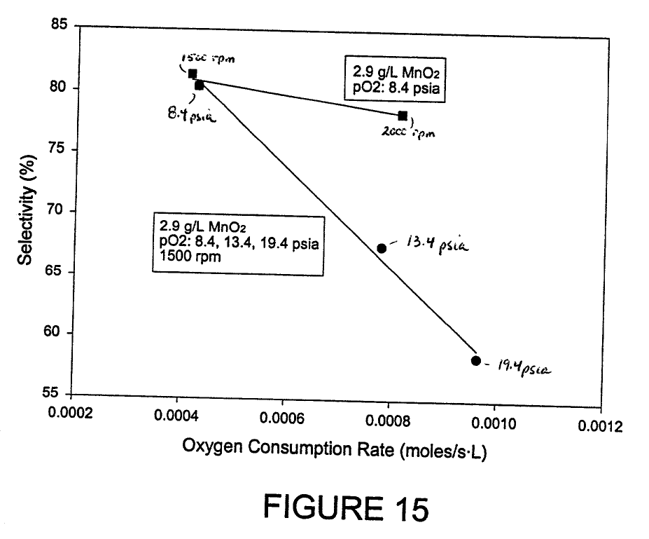

A hollow shaft reactor offers the important advantage of careful control of the oxygen partial pressure. In sodium polysulfides production, the reaction is controlled by the mass transfer of the oxygen to the liquid phase. The selectivity is controlled by the availability of catalyst to direct the reaction towards the formation of sodium polysulfides. In a hollow shaft reactor, the mass transfer rate can be increased by increasing the mixing rate or increasing the oxygen partial pressure. FIG. 15 shows that maintaining a low oxygen partial pressure while increasing the mixing rate still maintains a good selectivity.

### Example 5

In the prior art, lime mud is important since it can act as a catalyst (due to the presence of metallic impurities) for polysulfide production. However, in some cases, metals such as magnesium can play the role of inhibitors. The level of magnesium should be maintained below 10,000 ppm in the lime mud to prevent having to use more than 2.5 g/l MnO₂, which is preferably the maximum to be added to the mud cycle. An experiment demonstrating this was run as follows:

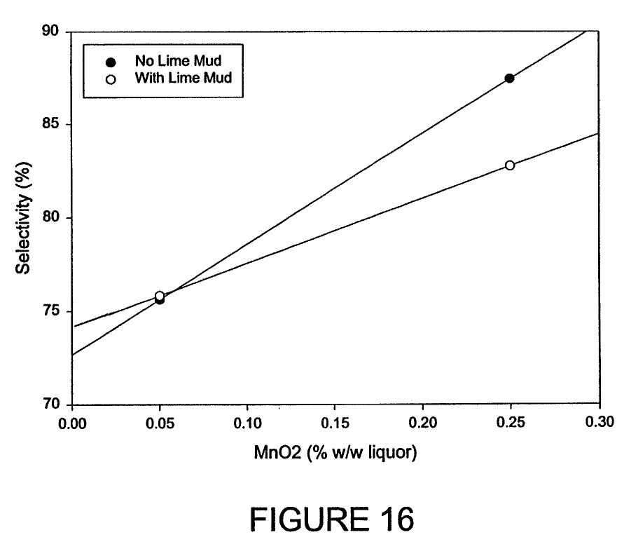

The liquor described in Example 1 was oxidized in the presence and the absence of lime mud. FIG. 16 shows that at a lower manganese dioxide concentration, no difference is observed in selectivity. However, when the amount of manganese dioxide is increased to 0.025 (w/w liquor), the presence of lime mud actually lowers the selectivity of the oxidation. This is contrary to U.S. Pat. No. 5,082,526, which teaches that the lime mud increases the selectivity of the oxidation reaction.

### Example 6

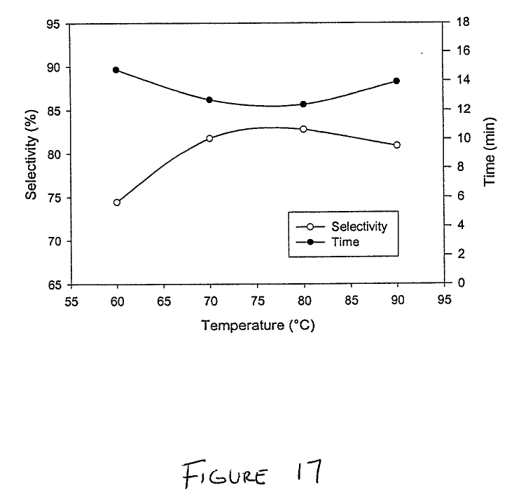

The effect of temperature on selectivity and time to reach the desired residual sulfide is shown in FIG. 17. The oxidation conditions were: 1500 rpm, 60% O₂, 600 ml/min of O₂ and 2.5 g/l MnO₂. There was no gas recirculation in the reactor. The maximum selectivity was reached at the minimum time at a temperature of approximately 75-80° C.

### Example 7

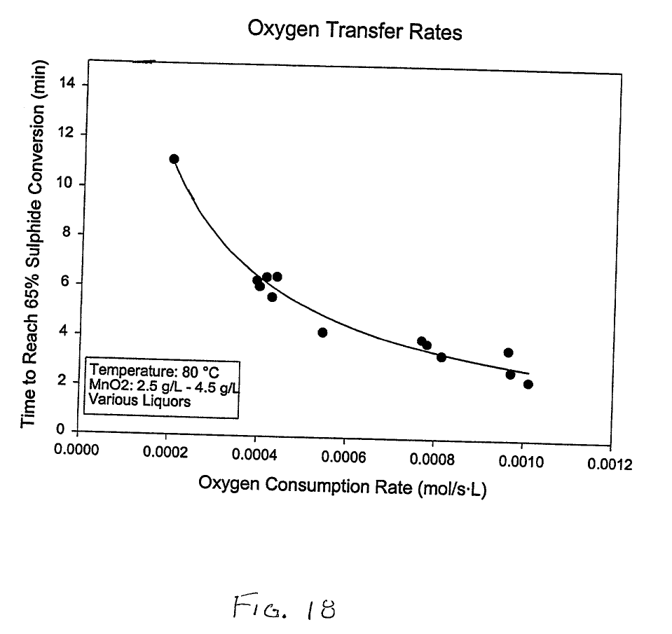

Runs were made to demonstrate the benefits of polysulfide production in accordance with the present invention, the results of which are shown in FIG. 18. The residence time for achieving at least 65% sulfide conversion is shown relative to the oxygen consumption rate. It can be seen from the graph that using the high consumption rates of the present invention, particularly at least 2.0 moles/l/sec, and at least 4.0 moles/l/sec, one can achieve at least 65% sulfide conversion in a very short residence time, which also permits one to maximize polysulfide production and selectivity.

While the invention has been described with preferred embodiments, it is to be understood that variations and modifications may be resorted to as will be apparent to those skilled in the art. Such variations and modifications are to be considered within the purview and the scope of the claims appended hereto.

What is claimed is:

1. A process for preparing polysulfides, comprising reacting sodium sulfide with oxygen in the presence of a transition metal oxide, with the concentration of the catalyst ranging from 0.05 to 6.5 g/l, where the consumption rate of O₂ is at least 1.5×10⁻⁴ moles/l/sec, such that a selectivity of polysulfides greater than 65% is achieved.

2. The process of claim 1, wherein the consumption rate Of O₂ is at least 2×10⁻⁴ moles/l/sec.

3. The process of claim 1, wherein the consumption rate of O₂ is at least 4×10⁻⁴ moles/l/sec.

4. The process of claim 1, wherein the reaction is conducted in a self-recirculated reactor.

5. The process of claim 4, wherein the reactor is a hollow shaft reactor.

6. The process of claim 1, wherein the transition metal oxide is MnO₂.

7. The process of claim 1, wherein the consumption rate of oxygen is controlled through the control of the partial pressure of oxygen in the reaction.

8. The process of claim 4, wherein the consumption rate of oxygen is controlled through the control of the partial pressure of oxygen in the reaction.

9. The process of claim 1, wherein the temperature at which the reaction is conducted is in the range of from about 70 to 99° C.

10. The process of claim 9, wherein the temperature is in a range of from about 75 to 85° C.

11. The process of claim 9, wherein the temperature is in the range of from about 75 to 80° C.

12. The process of claim 4, wherein the retention time in the reactor range is from about 2 to 15 minutes.

13. The process of claim 12, wherein the retention time ranges from about 3 to 10 minutes.

14. The process of claim 12, wherein the retention time ranges from about 3 to 5 minutes.

15. The process of claim 4, wherein the oxygen consumption is greater than 4×10⁻⁴ moles/l/sec.

16. The process of claim 1, wherein the selectivity is greater than 75%.

17. The process of claim 1, wherein the selectivity is greater than 90%.

18. A process for preparing polysulfides, comprising reacting Na₂S with oxygen in the presence of a transition metal oxide, with a concentration of the metal oxide ranging from 0.05 to 6.5 g/l, and where the consumption rate of O₂ is sufficient and the partial pressure of oxygen is controlled to achieve a selectivity of polysulfides greater than at least 85%.

19. The process of claim 18, wherein the selectivity of polysulfides achieved is greater than at least 90%.

20. The process of claim 18, wherein the reaction is conducted in a self-recirculated reactor.

21. The process of claim 18, wherein the reaction is conducted in a hollow shaft self-recirculated reactor.

22. The process of claim 18, wherein the transition metal oxide is MnO₂.
